(19) United States
(12) Patent Application Publication
(10) Pub. No.: US 2026/0062652 A1
(43) Pub. Date: Mar. 5, 2026

(54) WHITENING AND STAIN-REMOVING LAUNDRY SHEET AND PREPARATION METHOD THEREOF

(71) Applicant: Guangzhou Joyson Cleaning Products Co., Ltd., Guangzhou (CN)

(72) Inventors: Fenglei LI, Guangzhou (CN); Min SUN, Guangzhou (CN); Jieer LUO, Guangzhou (CN); Jieting YAN, Guangzhou (CN); Junli LI, Guangzhou (CN)

(21) Appl. No.: 18/926,510

(22) Filed: Oct. 25, 2024

Related U.S. Application Data
(63) Continuation of application No. PCT/CN2024/116906, filed on Sep. 4, 2024.

(51) Int. Cl. C11D 17/06; C11D 1/83; C11D 3/20; C11D 3/22; C11D 3/37; C11D 3/382; C11D 3/386; C11D 3/42; C11D 3/48

(52) U.S. Cl. CPC C11D 17/06; C11D 1/8305; C11D 3/2065; C11D 3/225; C11D 3/3753; C11D 3/382; C11D 3/38627; C11D 3/42; C11D 3/48; C11D 2111/12; C11D 2111/44

(57) ABSTRACT

The present application relates to a technical field of washing products, and, in particular, to a whitening and stain-removing laundry sheet and a preparation method thereof. A whitening and stain-removing laundry sheet includes: a film-forming agent, an anionic surfactant, a nonionic surfactant, a fluorescent whitening agent, an anti-fouling agent, an enzyme preparation, a plant extract, a chelating agent, and an auxiliary; the film-forming agent includes a film-forming agent A and a film-forming agent B; the film-forming agent A is polyvinyl alcohol, and the film-forming agent B is at least one selected from a group consisting of: polyvinylpyrrolidone and a modified polyvinyl alcohol. The whitening and stain-removing laundry sheet of the present application has strong solubility, significant whitening effect on fabrics, and possesses stain-removing ability. The whitening and stain-removing laundry sheet also has advantages of being convenient to carry, easy to use, and leaving no solid residues after use.

### CROSS-REFERENCE TO RELATED APPLICATION

The present application is a continuation of PCT application serial No. PCT/CN2024/116906, filed on Sep. 4, 2024. The entirety of PCT application serial No. PCT/CN2024/116906 is hereby incorporated by reference herein and made a part of this specification.

### TECHNICAL FIELD

The present application relates to a technical field of washing products, and, in particular, to a whitening and stain-removing laundry sheet and a preparation method thereof.

### BACKGROUND ART

With an aging of fabric substrates, a color of the fabric substrates tends to fade or yellow due to a natural degradation of fibers exposed to light and air. Currently, a whitening agent is commonly used to solve problems such as yellowing of fabrics. A whitening effect of a fluorescent whitening agent is actually an optical effect that does not damage fibers of clothes or textiles, but the fluorescent whitening agent can only make fabrics whiter, and cannot improve cleanliness of fabrics.

Currently, a content of the whitening agent in washing products is usually 0.1%-0.5%, which is a trace addition. Therefore, an effect of whitening fabrics is not significant during a washing process.

Most of whitening washing products currently on the market that have a whitening effect on fabrics are in liquid form.

For example, Chinese patents CN202010444733.X and CN201610101477.8 provide technical solutions about a liquid fluorescent whitening agent composition, with a fluorescent whitening agent content up to 30%, but the liquid fluorescent whitening agent composition lacks washing and stain-removing abilities and has a short shelf life.

For example, Chinese patents CN202310421252.0 and CN201610643400.3 provide technologies about a whitening laundry detergent with a washing effect, and the fluorescent whitening agent content in the whitening laundry detergent does not exceed 10%. Both the whitening agent and the whitening laundry detergent are difficult to control in actual use. An undiluted whitening laundry detergent, if directly contacting the fabric, can cause the whitening agent to rapidly adsorb onto fabrics, leading to uneven whitening and color spots.

Currently, a fabric whitening sheet on the market mainly uses a fiber cloth as a carrier to bond or adsorb a large amount of the whitening agent, but the fabric whitening sheet also lacks washing and stain-removing functions. For example, Chinese patents CN201910736357.9 and CN201910713427.9 provide technologies about a whitening sheet. Although the whitening sheet is portable and easy to carry, there are still the following problems during actual use: (1) the fluorescent whitening agent bonded is prone to falling off and migrating, resulting in poor whitening effect; (2) the fiber cloth is easily wrapped by fabrics, causing local color differences during washing; (3) fibers that fall off during washing can adhere to fabrics, causing secondary processing; (4) after washing, the fiber cloth still needs to be manually discarded and disposed of by an user.

Based on the above problems, there is an urgent need to seek solutions.

### SUMMARY

In order to solve the above problems, the present application provides a whitening and stain-removing laundry sheet and a preparation method thereof. The whitening and stain-removing laundry sheet obtained through the present application has strong solubility, good whitening effect on fabrics, and also possesses stain-removing ability. Furthermore, the whitening and stain-removing laundry sheet also has advantages of being convenient to carry, easy to use, suitable for all washing equipment and leaving no solid residues after use.

In the whitening and stain-removing laundry sheet prepared by the present application, a fluorescent whitening agent is wrapped inside the laundry sheet, which can prevent the fluorescent whitening agent from falling off and migrating during product usage; and by adding a plant extract to avoid a use of chemical preservatives, the laundry sheet has a good development prospect.

In a first aspect, the present application provides a whitening and stain-removing laundry sheet adopting the following technical solution.

A whitening and stain-removing laundry sheet, prepared by drying a slurry, wherein the slurry includes the following raw materials by mass percentage:
a film-forming agent 10-30%, an anionic surfactant 10-30%, a nonionic surfactant 3-10%, a fluorescent whitening agent 11-30%, an anti-fouling agent 0.5-5%, an enzyme preparation 0.5-5%, a plant extract 0.1-1%, a chelating agent 0.5%-5%, an auxiliary 0.5-5% and water;
the film-forming agent comprises at least a film-forming agent A and a film-forming agent B; the film-forming agent A is polyvinyl alcohol, and the film-forming agent B is at least one selected from a group consisting of: polyvinylpyrrolidone and a modified polyvinyl alcohol;
the anionic surfactant comprises at least sodium alkyl sulfate, sodium fatty acid methyl ester sulfonate, and sodium alpha-olefin sulfonate;
the nonionic surfactant is at least one selected from a group consisting of: polyglyceryl fatty acid ester, fatty alcohol polyoxyethylene ether, isomeric alcohol polyoxyethylene ether, secondary alcohol polyoxyethylene ether, fatty acid methyl ester ethoxylate, alcohol ether glucoside, and alkyl glucoside.

Preferably, the mass percentage of the film-forming agent is 15-25%, the mass percentage of the anionic surfactant is 10-20%, the mass percentage of the nonionic surfactant is 3-5%, the mass percentage of the fluorescent whitening agent is 15-25%, and the mass percentage of the enzyme preparation is 1-3.5%.

By adopting the above technical solution, a polyhydroxy polymer such as the polyvinyl alcohol and polyvinylpyrrolidone are used as the film-forming agent while strongly hydrogen bonding with the fluorescent whitening agent to form a water-soluble polymer complex. After shaping, the film-forming agent “envelops” the fluorescent whitening agent, reducing a photodegradation and photoisomerization of the fluorescent whitening agent during processing and storage. Due to a special structure of the water-soluble polymer complex, the laundry sheet has an excellent water solubility. When washed in water, the laundry sheet can quickly dissolve and disperse in water, reducing a risk of uneven whitening and color spots caused by direct contact of the fluorescent whitening agent with fabrics.

Adding too little of the whitening agent to washing products cannot significantly whiten fabrics, while adding a high content of the fluorescent whitening agent poses certain technical difficulties. This is because the fluorescent whitening agent is prone to chelating divalent and trivalent metal ions to form a precipitate, reducing the whitening effect of the fluorescent whitening agent when used in hard water. The present application forms the water-soluble polymer complex by strong hydrogen bonding of the polyhydroxy polymer such as the polyvinyl alcohol and polyvinylpyrrolidone with the fluorescent whitening agent. When the whitening and stain-removing laundry sheet dissolves in water, a structure of the water-soluble polymer complex can prevent or slow down a direct binding of the fluorescent whitening agent with metal ions such as calcium and magnesium in water, ensuring the whitening effect of the whitening and stain-removing laundry sheet in hard water. With a coordination of a specific type of the film forming agent, the anionic surfactant and the non-ionic surfactant, the laundry sheet to be produced can contain a large amount of the fluorescent whitening agent, effectively and significantly whitening fabrics. Under the specific coordination, the laundry sheet to be produced has good moisture resistance, maximizing a stain-removing effect of the anionic surfactant and nonionic surfactant during use, thus achieving efficient whitening and stain removal.

Preferably, the mass percentage of the film-forming agent A is 10-20%, and the mass percentage of the film-forming agent B is 1-5%.

Preferably, the film-forming agent is a mixture of the film-forming agent A and the film-forming agent B; wherein the film-forming agent A is polyvinyl alcohol, and the film-forming agent B is a mixture of the polyvinylpyrrolidone and the modified polyvinyl alcohol.

Preferably, the modified polyvinyl alcohol is a carboxylated polyvinyl alcohol and/or a sulfonated polyvinyl alcohol.

Preferably, the anionic surfactant is a mixture of sodium alkyl sulfate, sodium fatty acid methyl ester sulfonate, and sodium alpha-olefin sulfonate.

Preferably, the mass percentage of the sodium alkyl sulfate is 8-15%, the mass percentage of the sodium fatty acid methyl ester sulfonate is 1-5%, and the mass percentage of the sodium alpha-olefin sulfonate is 1-3%.

Preferably, the nonionic surfactant is a mixture of polyglyceryl fatty acid ester, fatty alcohol polyoxyethylene ether, fatty acid methyl ester ethoxylate, and alkyl glucoside.

Preferably, the fatty alcohol polyoxyethylene ether is at least one selected from a group consisting of: fatty alcohol polyoxyethylene ether EO-7, and fatty alcohol polyoxyethylene ether EO-3.

Preferably, the mass percentage of the fatty alcohol polyoxyethylene ether EO-7 is 2-3%, the mass percentage of the fatty alcohol polyoxyethylene ether EO-3 is 0.5-1%, the mass percentage of the polyglyceryl fatty acid ester is 0.1-1%, the mass percentage of the fatty acid methyl ester ethoxylate is 0.3-3%, and the mass percentage of the alkyl glucoside is 0.1-1%.

Preferably, the fluorescent whitening agent is at least one selected from a group consisting of: a bis (triazine amino) stilbene fluorescent whitening agent (VBL) and a bis-styrylbiphenyl fluorescent whitening agent (CBS-X).

Preferably, the fluorescent whitening agent is a mixture of the bis (triazine amino) stilbene fluorescent whitening agent and the bis-styrylbiphenyl fluorescent whitening agent. The mass percentage of the bis (triazine amino) stilbene fluorescent whitening agent is 1-5%, and the mass percentage of the bis-styrylbiphenyl fluorescent whitening agent is 10-20%.

Preferably, the auxiliary agent is at least one selected from a group consisting of: a polyol and sodium carboxymethyl cellulose.

Preferably, the polyol is at least one selected from a group consisting of: polysiloxane alcohol, glycerol, propylene glycol, pentylene glycol, butylene glycol, hexylene glycol, and sorbitol.

Preferably, the polyol is a mixture of the polysiloxane alcohol, glycerol, and sorbitol. The mass percentage of the polysiloxane alcohol is 0.1-0.5%, the mass percentage of the glycerol is 0.5-2%, and the mass percentage of the sorbitol is 0.1-1%.

In practical research, it has been found that if a large amount of the fluorescent whitening agent is added without the auxiliary agent, a texture of the laundry sheet to be prepared would become brittle and easy to break in low humidity, resulting in poor storage stability.

By adopting the above technical solution, further optimizing the auxiliary agent as the polyol, using water retention and locking properties of polyol hydroxyl groups, the storage stability of the whitening and stain-removing laundry sheet is improved.

Preferably, the enzyme preparation is at least two selected from a group consisting of: protease, amylase, lipase, cellulase, pectinase, mannanase, and phosphodiesterase.

Preferably, the enzyme preparation is a mixture of the protease, the amylase, and the lipase. The mass percentage of the protease is 1-3%, the mass percentage of the amylase is 0.1-3%, and the mass percentage of the lipase is 0.5-1.5%.

Preferably, the plant extract comprises at least a Sapindus extract, a tea tree oil extract, and a Camellia oleifera extract.

Preferably, the Sapindus extract, the tea tree oil extract, and the Camellia oleifera extract are mixed in a ratio of (0.2-0.4):(0.1-0.3):(0.1-0.2).

By adopting the above technical solution, selecting specific plant extracts for coordination, it can not only achieve a good preservative effect, avoid the use of chemical preservatives, but also add a plant aroma to the laundry sheet.

Preferably, the anti-fouling agent is at least one selected from a group consisting of: a hydrophobic modified acrylic polymer and a water-soluble nonionic polyester.

Preferably, a molecular weight of the hydrophobic modified acrylic polymer is 30,000-50,000 and a Brookfield viscosity of the hydrophobic modified acrylic polymer is 0-500 cPs.

Combining the hydrophobically modified acrylic polymer can promote a shedding of sebum and oils from fabrics, enhancing the whitening effect of fabrics during use.

The water-soluble nonionic polyester can prevent stains from penetrating deep into fabrics, providing protection for fabrics and an excellent anti-scale and redeposition effect during a second cleaning.

The above preferred anti-fouling agent can not only improve a stain-removing power against sebum stains, but also provide an excellent whiteness retention performance, maintain formula stability, and increase formula viscosity.

Preferably, the mass percentage of the hydrophobic modified acrylic polymer is 1-3%, and the mass percentage of the water-soluble nonionic polyester is 0.5-2%.

In a second aspect, the present application provides a method for preparing the whitening and stain-removing laundry sheet, adopting the following technical solution.

A method for preparing the whitening and stain-removing laundry sheet, including the following steps:
step 1: mixing water and the film-forming agent at 85-90° C. until uniform;
step 2: adding the chelating agent and then mixing until uniform;
step 3: adding the anionic surfactant, the nonionic surfactant and the anti-fouling agent, and then mixing until uniform;
step 4: adding the fluorescent whitening agent at 50-60° C. and then mixing until uniform;
step 5: adding the plant extract and mixing until uniform;
step 6: drying and shaping into a sheet to obtain a semi-finished laundry sheet; and
step 7: spraying the enzyme preparation onto the semi-finished laundry sheet to obtain the whitening and stain-removing laundry sheet.

The fluorescent whitening agent can easily bind with the enzyme preparation through electrostatic interactions, causing changes in a conformation of enzymes, which can affect a stain removal effect. The present application not only enhances the stain removal effect and the whitening effect by selecting the specific type of the film-forming agent, the anionic surfactant, and the nonionic surfactant, but also adds the enzyme preparation through spraying, further preventing direct interaction between the fluorescent whitening agent and the enzyme preparation, thus not affecting a stain-removing activity of the enzymes.

In summary, the present application includes the following beneficial technical effects.
1. The present application uses the specific type of the film-forming agent in coordination with the fluorescent whitening agent to form the water-soluble polymer complex, which reduces the photodegradation and photoisomerization of the fluorescent whitening agent during processing and storage. Moreover, due to the excellent water solubility of the laundry sheet, the laundry sheet can quickly dissolve and disperse in water, reducing the risk of uneven whitening and color spots caused by direct contact of the fluorescent whitening agents with fabrics.
2. With the coordination of the specific type of the film forming agent, the anionic surfactant and the non-ionic surfactant, the laundry sheet to be produced can contain a large amount of the fluorescent whitening agent and has good moisture resistance, maximizing the stain-removing effect of the anionic surfactant and the nonionic surfactant during use, thus achieving efficient whitening and stain removal.
3. In the method of the present application, the enzyme preparation is added through spraying, further preventing direct interaction between the fluorescent whitening agent and the enzyme preparation, thus not affecting the stain-removing activity of the enzymes.
4. In the whitening and stain-removing laundry sheet prepared by the present application, the fluorescent whitening agent is wrapped inside the laundry sheet, which can prevent the fluorescent whitening agent from falling off and migrating during product usage, thereby providing a long-lasting whitening effect.
5. The present application uses specific plant extracts for coordination, which can not only achieve the good preservative effect, avoid the use of chemical preservatives, but also add the plant aroma to the laundry sheet.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows test results of Test One in the present application, with a test sample usage of 2 g; the test sample includes the whitening and stain-removing laundry sheet of Example 3, commercial non-woven whitening sheet A, commercial non-woven whitening sheet B, and commercial non-woven whitening sheet C.

FIG. 2 shows the test results of Test One in the present application, with the test sample usage of 4 g; the test sample includes the whitening and stain-removing laundry sheet of Example 3, commercial non-woven whitening sheet A, commercial non-woven whitening sheet B, and commercial non-woven whitening sheet C.

FIG. 3 shows the test results of Test One in the present application, with the test sample usage of 2 g; the test sample includes the whitening and stain-removing laundry sheet of Example 3, commercial whitening laundry detergent A, and commercial whitening laundry detergent B.

### DETAILED DESCRIPTION

The present application will be further described in detail below with reference to the drawings and Examples.

The raw materials used in the following Examples and Comparative Examples are all commercial products.

The following is an explanation of sources for some of the raw materials.

Polyvinyl alcohol can be selected from Changchun Chemical (Jiangsu) Co., Ltd., with product numbers BP-05 or BP-17.

Polyvinylpyrrolidone can be selected from K30/60/90.

Polysiloxane alcohol can be selected from water-soluble series of Wacker Chemie AG.

Modified polyvinyl alcohol can be a carboxylated polyvinyl alcohol and/or a sulfonated polyvinyl alcohol, can be selected from KL-318 of Guangzhou Qi Hua Chemical Co., Ltd.

Polyglyceryl fatty acid ester can be selected from Shandong Binzhou Jingsheng New Material Technology Co., Ltd.

Water-soluble nonionic polyester can be selected from TexCare® SRN 100, Dow Chemical Technology Co., Ltd. in the United States.

The hydrophobically modified acrylic polymer with a molecular weight of 30,000-50,000 and Brookfield viscosity of 0-500 cPs, can be selected from ACUSOL 845, Dow Chemical Technology Co., Ltd. in the United States.

### EXAMPLES

### Examples 1-6

A whitening and stain-removing laundry sheet, prepared by drying a slurry, the slurry included the raw materials as shown in Table 1.

The present application also provides a method for preparing the whitening and stain-removing laundry sheet, the method included the following steps:
Step 1: The film-forming agent was mixed with an appropriate amount of deionized water, heated to 88° C., and stirred at a constant temperature until a first result material swells and dissolves uniformly.
Step 2: The chelating agent was dissolved at a mass ratio of 1:1 with deionized water, then added to the first result material in Step 1, mixed until uniform to obtain a second result material.
Step 3: The anti-soiling agent was premixed with an appropriate amount of deionized water until uniform, then added along with the anionic surfactant and nonionic surfactant to the second result material in Step 2, and mixed until uniform to obtain a third result material.
Step 4: The fluorescent whitening agent was dissolved in an appropriate amount of deionized water. The third result material in Step 3 was cooled to 55° C., then quickly added the fluorescent whitening agent to the third result material in Step 3, stirred until fully dissolved and uniform to obtain a fourth result material.
Step 5: The plant extract and the remaining deionized water were added to the fourth result material in Step 4, stirred until uniform to obtain the slurry.
Step 6: The slurry was dried and shaped into a sheet to obtain a semi-finished laundry sheet.
Step 7: The enzyme preparation (liquid) was sprayed onto the semi-finished laundry sheet to obtain the whitening and stain-removing laundry sheet.

Unless otherwise specified, the amount of deionized water used can be adjusted based on actual conditions, used only for uniform dissolution, without strict requirements.

TABLE 1

| | | Examples (Unit: kg) | | | | | |
|---|---|---|---|---|---|---|---|
| Types | Components | 1 | 2 | 3 | 4 | 5 | 6 |
| Film-forming | Polyvinyl alcohol | 10 | 20 | 15 | 9 | 20 | 10 |
| agent | Polyvinylpyrrolidone | 0.5 | 2 | 2 | 0 | 10 | 8 |
| | Modified polyvinyl | 0.5 | 3 | 2 | 1 | 0 | 5 |
| | alcohol | | | | | | |
| Anionic | Sodium alkyl sulfate | 8 | 15 | 10 | 16 | 15 | 12 |
| surfactant | Alpha-olefin | 1 | 3 | 3 | 8 | 1 | 4 |
| | sulfonate | | | | | | |
| | Sodium fatty acid | 1 | 5 | 2 | 6 | 1 | 1.5 |
| | methyl ester | | | | | | |
| | sulfonate | | | | | | |
| Nonionic | Fatty alcohol | 2 | 3 | 2.5 | 6 | 2 | 3 |
| surfactant | polyoxyethylene | | | | | | |
| | ether EO-7 | | | | | | |
| | Fatty alcohol | 0.5 | 1 | 0.5 | 0 | 0.5 | 0.3 |
| | polyoxyethylene | | | | | | |
| | ether EO-3 | | | | | | |
| | Fatty acid methyl | 0.3 | 3 | 0.4 | 2 | 2.5 | 0.5 |
| | ester ethoxylate | | | | | | |
| | Alkyl glucoside | 0.1 | 1 | 0.2 | 2 | 0 | 0 |
| | Polyglyceryl fatty | 0.1 | 1 | 0.1 | 0 | 0 | 0.2 |
| | acid ester | | | | | | |
| Fluorescent | CBS-X | 20 | 10 | 18 | 27 | 13 | 11 |
| whitening | VBL | 1 | 5 | 0 | 3 | 2 | 5 |
| agent | | | | | | | |
| Chelating | Trisodium | 0 | 1 | 0.5 | 0 | 2 | 1.5 |
| agent | methylglycine | | | | | | |
| | diacetate | | | | | | |
| | Trisodium aspartate | 0.5 | 0 | 0.5 | 0.25 | 1 | 1 |
| | diacetate | | | | | | |
| | Sodium citrate | 1 | 0.5 | 1 | 0.25 | 2 | 0.5 |
| Enzyme | Cellulase | 0 | 0.3 | 0 | 0.2 | 0.1 | 0.1 |
| preparation | Protease | 1 | 1.2 | 1.1 | 0 | 1.5 | 2.5 |
| | Amylase | 0.2 | 0.2 | 0.3 | 3 | 1 | 0 |
| | Lipase | 0 | 0 | 1 | 0 | 0 | 0.5 |
| Plant extract | Sapindus extract | 0.2 | 0.4 | 0.4 | 0.3 | 0.4 | 0.4 |
| | Tea tree oil extract | 0.1 | 0.3 | 0.2 | 0.1 | 0.3 | 0.1 |
| | Camellia oleifera | 0.2 | 0.2 | 0.1 | 0.1 | 0.2 | 0.1 |
| | extract | | | | | | |
| Anti-fouling | Hydrophobic | 1 | 3 | 2 | 2.5 | 3 | 3 |
| agent | modified acrylic | | | | | | |
| | polymer | | | | | | |
| | Water-soluble | 0.5 | 1 | 2 | 1.2 | 0.5 | 0 |
| | nonionic polyester | | | | | | |
| Auxiliary | Glycerol | 0.5 | 2 | 0.7 | 0.6 | 1 | 2 |
| | Polysiloxane alcohol | 0.2 | 0.5 | 0.1 | 0.4 | 0.5 | 0 |
| | Sorbitol | 0.1 | 1 | 0.5 | 0 | 0 | 1 |

| | | | | | | |
|---|---|---|---|---|---|---|
| Water | 50.7 | 16.4 | 33.9 | 11.1 | 19.5 | 26.8 |

### COMPARATIVE EXAMPLES

### Comparative Example 1

A whitening and stain-removing laundry sheet, differing from Example 3 in that: the film-forming agent was replaced with corn starch.

### Comparative Example 2

A whitening and stain-removing laundry detergent, differing from Example 3 in that: the film-forming agent was replaced with water.

A method for preparing the whitening and stain-removing laundry detergent, differing from Example 3 in that: the method included the following steps:
Step 1: The chelating agent was dissolved at a mass ratio of 1:1 with deionized water.
Step 2: The anti-soiling agent was premixed with an appropriate amount of deionized water until uniform, then added along with the anionic surfactant and nonionic surfactant to a result material in Step 1. A mixing temperature was set to 88° C.
Step 3: The fluorescent whitening agent was dissolved in an appropriate amount of deionized water. A result material in Step 2 was cooled to 55° C., then quickly added the fluorescent whitening agent to the result material in Step 2, stirred until fully dissolved and uniform.
Step 4: The plant extract and the remaining deionized water were added to a result material in Step 3, stirred until uniform to obtain the slurry.
Step 5: The enzyme preparation was added to the slurry to obtain the whitening and stain-removing laundry detergent.

### Comparative Example 3

A whitening and stain-removing laundry detergent that included 8 kg of fatty alcohol polyoxyethylene ether sulfate triethanolamine salt, 10 kg of sodium dodecyl sulfate, 5 kg of sodium lauryl oxyethyl sulfonate, 18 kg of fluorescent whitening agent (CBS-X), 4 kg of C12-18 alkyl glucoside, 11 kg of ammonium cocomonoglyceride sulfate, 8 kg of rosin alcohol polyoxyethylene ether succinic acid monosulfonate sodium, and 36 kg of water.

All raw materials were mixed until uniform to obtain the whitening and stain-removing laundry detergent.

After the whitening and stain-removing laundry detergent has settled for 1 hour, precipitation occurs.

### Comparative Example 4

A whitening and stain-removing laundry sheet, differing from Example 3 in that: the anionic surfactant was omitted and replaced with an equivalent amount of the fatty alcohol polyoxyethylene ether EO-7.

### Comparative Example 5

A whitening and stain-removing laundry sheet, differing from Example 3 in that: the nonionic surfactant was omitted and replaced with an equivalent amount of the sodium dodecyl sulfate.

### Comparative Example 6

A whitening and stain-removing laundry sheet, differing from Example 3 in that: the sodium dodecyl sulfate was replaced with sodium dodecylbenzenesulfonate, the sodium alpha-olefin sulfonate was replaced with sodium lauryl oxyethyl sulfonate, and the sodium fatty acid methyl ester sulfonate was replaced with sodium fatty alcohol polyoxyethylene ether sulfate.

### Comparative Example 7

A whitening and stain-removing laundry sheet, differing from Example 3 in that: the alkyl glucoside was replaced with dodecyl-β-D-maltoside, the polyglyceryl fatty acid ester and the fatty acid methyl ester ethoxylate were replaced with polyoxyethylene amide, and the fatty alcohol polyoxyethylene ether EO-7 and EO-3 were replaced with Tween 80.

### Comparative Example 8

A whitening and stain-removing laundry sheet, differing from Example 3 in that: the auxiliary was replaced with water.

The whitening and stain-removing laundry sheet of Comparative Example 8, when stored at low humidity (20-40%) for 24-48 hours, showed cracking and some of them broke into uneven fragments.

The whitening and stain-removing laundry sheets of Examples 1-6, when stored at low humidity (20-40%) for 24-48 hours, showed no cracking.

### Moisture Resistance Stability Testing:

Two whitening and stain-removing laundry sheets were stacked and placed in a test environment at a temperature of (25±2)° C. and humidity of (85±5)% for 24 hours. Afterwards, the two laundry sheets were separated to observe whether there is adhesion between them. The adhesion can be classified into no adhesion, slight adhesion, and obvious adhesion.

The whitening and stain-removing laundry sheet of Comparative Example 8 showed obvious adhesion, while the whitening and stain-removing laundry sheets of Examples 1-6 all showed no adhesion.

### Comparative Example 9

A method for preparing a whitening and stain-removing laundry sheet, differing from Example 3 in that: the method included the following steps:
Step 1: the film-forming agent was mixed with an appropriate amount of deionized water, heated to 88° C., and stirred at a constant temperature until a first result material swells and dissolves uniformly.
Step 2: the chelating agent was dissolved at a mass ratio of 1:1 with deionized water, then added to the first result material in Step 1, mixed until uniform to obtain a second result material.
Step 3: the anti-soiling agent was premixed with an appropriate amount of deionized water until uniform, then added along with the anionic surfactant and nonionic surfactant to the second result material in Step 2, and mixed until uniform to obtain a third result material.
Step 4: the fluorescent whitening agent was dissolved in an appropriate amount of deionized water. The third result material in Step 3 was cooled to 55° C., then quickly added the fluorescent whitening agent to the third result material in Step 3, stirred until fully dissolved and uniform to obtain a fourth result material.
Step 5: the plant extract and the remaining deionized water were added to the fourth result material in Step 4, stirred until uniform to obtain the slurry.
Step 6: the enzyme preparation was added to the slurry in Step 5 and mixed until uniform.
Step 7: the slurry was dried and shaped into a sheet to obtain the whitening and stain-removing laundry sheet.

### Performance Testing

### Test One: Whitening

### 1. Whitening Effect

A pure cotton white cloth was photographed under natural light; a comparative photo of the pure cotton white cloth was taken under a fluorescent lamp (model: ZF-7 standard).

A piece of pure cotton white cloth and a test sample (2 g or 4 g) were placed together in a washing machine and washed with tap water under normal conditions (washing, rinsing, and dehydrating); a water temperature was 25±1° C. After an entire washing process was completed, the pure cotton white cloth was taken out.

The pure cotton white cloth was dried in a drying oven (model: KH-55A) at 120° C. for 25 minutes, and then the pure cotton white cloth washed with the whitening and stain removing laundry sheet was photographed under the fluorescent lamp (model: ZF-7 standard) for comparison.

The test sample included the whitening and stain-removing laundry sheet of Example 3, commercial non-woven whitening sheet A, commercial non-woven whitening sheet B, commercial non-woven whitening sheet C, commercial whitening laundry detergent A, and commercial whitening laundry detergent B.

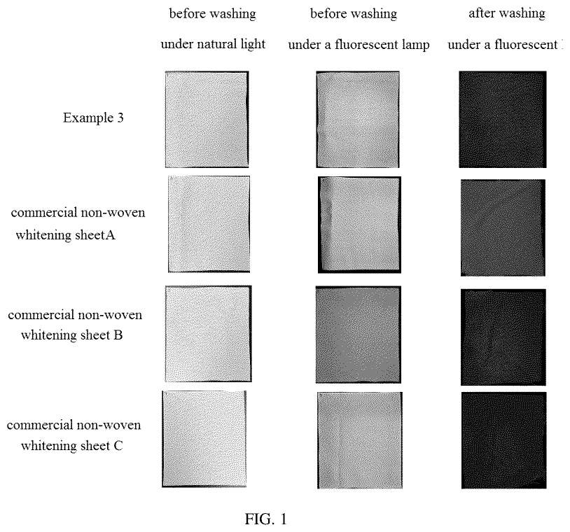

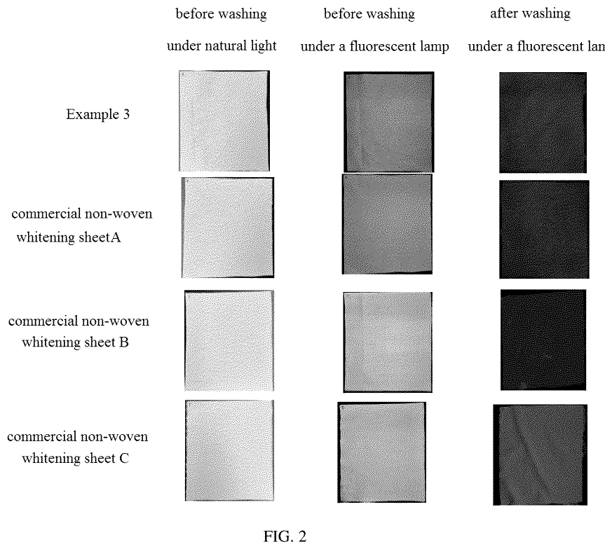

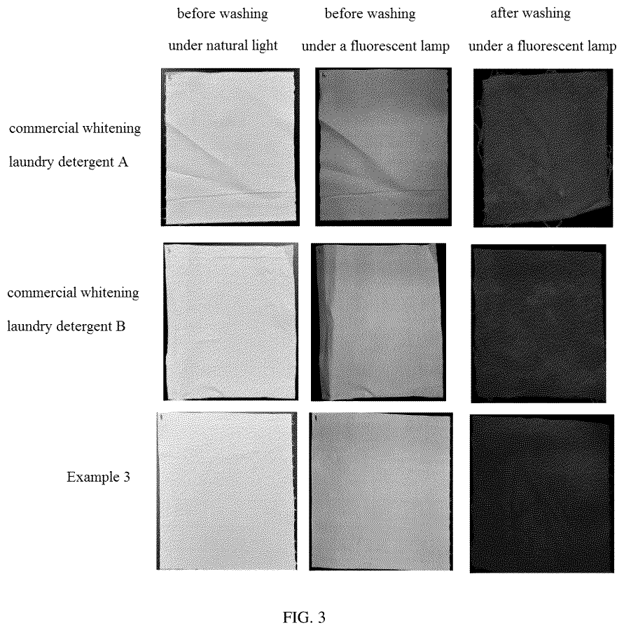

Test results were detailed in FIGS. 1-3, wherein FIG. 1 and FIG. 3 were from test groups with a test sample usage of 2 g, and FIG. 2 was from the test groups with the sample usage of 4 g.

According to the test results shown in FIG. 1 and FIG. 2, it can be seen that the whitening and stain-removing laundry sheet from Example 3 has a good whitening effect on pure cotton white cloth. However, the whitening effect of commercial non-woven whitening sheets A, B, and C on the pure cotton white cloth is not as good as the whitening and stain-removing laundry sheet from Example 3.

According to the test results shown in FIG. 3, it can be clearly seen that when using commercial whitening laundry detergents A and B to treat the pure cotton white cloth, the fluorescent whitening agent is uniformly adsorbed and distributed on the pure cotton white cloth under the fluorescent light. In contrast, the pure cotton white cloth washed with the whitening and stain-removing laundry sheet from Example 3 showed a uniform distribution of the fluorescent whitening agent.

### Whitening Value:

A whiteness value of the pure cotton white cloth was measured using a digital fluorescent whiteness meter (model: WSB-3C), which is the initial whiteness value.

A piece of pure cotton white cloth and the test sample (2 g or 4 g) were placed together in the washing machine and washed with tap water under normal conditions (washing, rinsing, and dehydrating); the water temperature was 25±1° C. After the entire washing process was completed, the pure cotton white cloth was taken out.

The cloth is dried in the drying oven (model: KH-55A) at 120° C. for 25 minutes; the whiteness value of the pure cotton white cloth to be washed was measured using the digital fluorescent whiteness meter (model: WSB-3C).

The whitening value was calculated using the following method and recorded in Table 2.

A calculation method of the whitening value: Five data points were taken, the maximum and minimum values of the data points were excluded and an average of the three middle data points was taken.

The test sample included the whitening and stain-removing laundry sheets from Examples 1-5 and Comparative Examples 1 and 4-9, whitening and stain-removing laundry detergents from Comparative Examples 2-3, commercial non-woven whitening sheet A, commercial non-woven whitening sheet B, commercial non-woven whitening sheet C, commercial whitening laundry detergent A, and commercial whitening laundry detergent B.

TABLE 2

| | Whitening values | |
|---|---|---|
| Groups | 2 g | 4 g |
| Example 1 | 21.12 | 21.17 |
| Example 2 | 20.88 | 21.36 |
| Example 3 | 24.34 | 25.06 |
| Example 4 | 17.85 | 18.07 |
| Example 5 | 18.03 | 18.38 |
| Comparative Example 1 | do not shape into a sheet | |
| Comparative Example 2 | 16.20 | 16.65 |
| Comparative Example 3 | 15.02 | 15.44 |
| Comparative Example 4 | do not shape into a sheet | |
| Comparative Example 5 | do not shape into a sheet | |
| Comparative Example 6 | 16.86 | 17.09 |
| Comparative Example 7 | 17.01 | 17.26 |
| Comparative Example 8 | 23.05 | 23.40 |
| Comparative Example 9 | 20.58 | 21.06 |
| Commercial non-woven whitening sheet A | 13.49 | 13.23 |
| Commercial non-woven whitening sheet B | 10.34 | 10.54 |
| Commercial non-woven whitening sheet C | 12.72 | 13.56 |
| Commercial whitening laundry detergent A | 0.74 | 0.95 |
| Commercial whitening laundry detergent B | 0.75 | 1.01 |

### Test Two: Stain Removal

The test was conducted according to GB/T 13174-2021 “Determination of stain-removing power and cyclic washing performance of laundry detergents for fabrics”.

Test pieces used were JB-01, JB-02, and JB-03 stained cloths. The test pieces were placed together with 2 g of the test sample in the washing machine and washed normally with tap water (washing, rinsing, and dehydrating); the water temperature was 25±1° C. After the entire washing process was completed, the test pieces were taken out and dried in the drying oven (model: KH-55A) at 120° C. for 25 minutes.

A stain removal ratio Pi of the test pieces to be washed was calculated and recorded in Table 3.

Among them, when Pi≥1.0 is qualified, and when Pi<1.0 is unqualified.

The test sample included the whitening and stain-removing laundry sheets from Examples 1-5 and Comparative Examples 1 and 4-9, whitening and stain-removing laundry detergents from Comparative Examples 2-3, commercial non-woven whitening sheet A, and commercial whitening laundry detergent A.

TABLE 3

| | Stain removal ratio Pi | | | |
|---|---|---|---|---|
| | | | | Sum of stain |
| Groups | JB-01 | JB-02 | JB-03 | removal ratio |
| Example 1 | 1.09 | 4.28 | 1.59 | 6.96 |
| Example 2 | 1.07 | 4.62 | 1.58 | 7.27 |
| Example 3 | 1.07 | 5.97 | 2.10 | 9.14 |
| Example 4 | 1.05 | 3.38 | 1.36 | 5.79 |
| Example 5 | 1.06 | 3.65 | 1.45 | 6.16 |
| Comparative Example 1 | do not shape into a sheet | | | |
| Comparative Example 2 | 1.04 | 3.03 | 1.16 | 5.23 |
| Comparative Example 3 | 1.03 | 2.35 | 1.12 | 4.50 |
| Comparative Example 4 | do not shape into a sheet | | | |
| Comparative Example 5 | do not shape into a sheet | | | |
| Comparative Example 6 | 1.03 | 2.06 | 1.08 | 4.17 |
| Comparative Example 7 | 1.04 | 2.15 | 1.09 | 4.28 |
| Comparative Example 8 | 1.08 | 5.05 | 2.12 | 8.25 |
| Comparative Example 9 | 1.05 | 4.32 | 1.78 | 7.15 |
| Commercial non-woven | Pi < 1.0, | Pi < 1.0, | Pi < 1.0, | unqualified |
| whitening sheet A | unqualified | unqualified | unqualified | |
| Commercial whitening | 1.06 | 1.43 | 1.85 | 4.34 |
| laundry detergent A | | | | |

From testing data in Tables 2 and 3, it can be seen that the whitening and stain-removing laundry sheets from Examples 1-5 have better whitening and stain removal effects on the pure cotton cloth compared to commercial products.

In Comparative Example 1, corn starch was used as a substitute for the film-forming agent, although corn starch is also a polyhydroxy compound, it cannot form a special coordination with the specific raw materials in the system, thus affecting a film forming effect.

Comparative Example 2 was based on Example 3, omitting the film-forming agent and making the product in liquid form. The absence of the specific film-forming agent and the specific coordination with other raw materials resulted in a significant decrease in the whitening and stain removal effects.

Comparative Example 3 was a whitening and stain removing laundry detergent that simulated a mixture of surfactants and fluorescent whitening agents commonly available on the market. The product of Comparative Example 3 exhibited precipitation after being left to stand for 1 hour, indicating unstable performance, and the testing data in Tables 2 and 3 also showed poor whitening and stain removal effects.

In Comparative Examples 4 and 5, the specific anionic surfactants and nonionic surfactants were omitted respectively, resulting in products that do not shape into sheet.

In Comparative Examples 6 and 7, the specific anionic surfactants and nonionic surfactants were replaced with other common surfactants, which disrupted the special coordination between the specific surfactants, film-forming agents, and fluorescent whitening agents, resulting in a significant decrease in whitening and stain removal effects.

Comparative Example 8 was based on Example 3, omitting the auxiliary. Although a performance in whitening and stain removal was not significantly decreased, the moisture resistance stability was poor, and improper storage can easily lead to performance failure.

Comparative Example 9 was based on Example 3, where the enzyme preparation was directly mixed with other raw materials, resulting in an inability of the enzyme preparation to fully utilize its performance, especially with a significant impact on the stain removal performance.

The embodiment is merely an explanation of the present application and is not a limitation of the present application. Those skilled in the art can make non-creative modifications to the embodiment as needed after reading this specification, but as long as they are within the scope of the claims of the present application, they are protected by patent law.

What is claimed is:

1. A whitening and stain-removing laundry sheet, comprising the following raw materials by mass percentage:
10-30% of a film-forming agent, 10-30% of an anionic surfactant, 3-10% of a nonionic surfactant, 11-30% of a fluorescent whitening agent, 0.5-5% of an anti-fouling agent, 0.5-5% of an enzyme preparation, 0.1-1% of a plant extract, 0.5%-5% of a chelating agent, and 0.5-5% of an auxiliary agent;
the film-forming agent comprises at least a film-forming agent A and a film-forming agent B; the film-forming agent A is polyvinyl alcohol, and the film-forming agent B is at least one selected from a group consisting of: polyvinylpyrrolidone and a modified polyvinyl alcohol;
the anionic surfactant comprises at least one of sodium alkyl sulfate, sodium fatty acid methyl ester sulfonate, or sodium alpha-olefin sulfonate;
the nonionic surfactant is at least one selected from a group consisting of: polyglyceryl fatty acid ester, fatty alcohol polyoxyethylene ether, isomeric alcohol polyoxyethylene ether, secondary alcohol polyoxyethylene ether, fatty acid methyl ester ethoxylate, alcohol ether glucoside, and alkyl glucoside.

2. The whitening and stain-removing laundry sheet according to claim 1, wherein the film-forming agent is a mixture of the film-forming agent A and the film-forming agent B; wherein the film-forming agent A is polyvinyl alcohol, and the film-forming agent B is a mixture of the polyvinylpyrrolidone and the modified polyvinyl alcohol;
the anionic surfactant is a mixture of the sodium alkyl sulfate, the sodium fatty acid methyl ester sulfonate, and the sodium alpha-olefin sulfonate;
the nonionic surfactant is a mixture of the polyglyceryl fatty acid ester, the fatty alcohol polyoxyethylene ether, the fatty acid methyl ester ethoxylate, and the alkyl glucoside.

3. The whitening and stain-removing laundry sheet according to claim 1, wherein a mass percentage of the sodium alkyl sulfate in the whitening and stain-removing laundry sheet is 8-15%, a mass percentage of the sodium fatty acid methyl ester sulfonate in the whitening and stain-removing laundry sheet is 1-5%, and a mass percentage of the sodium alpha-olefin sulfonate in the whitening and stain-removing laundry sheet is 1-3%.

4. The whitening and stain-removing laundry sheet according to claim 2, wherein the fatty alcohol polyoxyethylene ether is at least one selected from a group consisting of: fatty alcohol polyoxyethylene ether EO-7 and fatty alcohol polyoxyethylene ether EO-3.

5. The whitening and stain-removing laundry sheet according to claim 4, wherein a mass percentage of the fatty alcohol polyoxyethylene ether EO-7 in the whitening and stain-removing laundry sheet is 2-3%, a mass percentage of the fatty alcohol polyoxyethylene ether EO-3 in the whitening and stain-removing laundry sheet is 0.5-1%, a mass percentage of the polyglyceryl fatty acid ester in the whitening and stain-removing laundry sheet is 0.1-1%, a mass percentage of the fatty acid methyl ester ethoxylate in the whitening and stain-removing laundry sheet is 0.3-3%, and the mass percentage of the alkyl glucoside is 0.1-1%.

6. The whitening and stain-removing laundry sheet according to claim 1, wherein the fluorescent whitening agent is at least one selected from a group consisting of: a bis (triazine amino) stilbene fluorescent whitening agent and a bis-styrylbiphenyl fluorescent whitening agent, a mass percentage of the bis (triazine amino) stilbene fluorescent whitening agent in the whitening and stain-removing laundry sheet is 1-5%, and a mass percentage of the bis-styrylbiphenyl fluorescent whitening agent in the whitening and stain-removing laundry sheet is 10-20%.

7. The whitening and stain-removing laundry sheet according to claim 1, wherein the auxiliary agent is at least one selected from a group consisting of: a polyol and sodium carboxymethyl cellulose.

8. The whitening and stain-removing laundry sheet according to claim 7, wherein the polyol is at least one selected from a group consisting of: polysiloxane alcohol, glycerol, propylene glycol, pentylene glycol, butylene glycol, hexylene glycol, and sorbitol.

9. The whitening and stain-removing laundry sheet according to claim 8, wherein a mass percentage of the polysiloxane alcohol in the whitening and stain-removing laundry sheet is 0.1-0.5%, a mass percentage of the glycerol in the whitening and stain-removing laundry sheet is 0.5-2%, and a mass percentage of the sorbitol in the whitening and stain-removing laundry sheet is 0.1-1%.

10. The whitening and stain-removing laundry sheet according to claim 1, wherein the enzyme preparation is at least two selected from a group consisting of: protease, amylase, lipase, cellulase, pectinase, mannanase, and phosphodiesterase.

11. The whitening and stain-removing laundry sheet according to claim 1, wherein the plant extract comprises at least a Sapindus extract, a tea tree oil extract, and a Camellia oleifera extract, the Sapindus extract, the tea tree oil extract, and the Camellia oleifera extract are mixed in a ratio of (0.2-0.4):(0.1-0.3):(0.1-0.2).

12. The whitening and stain-removing laundry sheet according to claim 1, wherein the anti-fouling agent is at least one selected from a group consisting of: a hydrophobic modified acrylic polymer and a water-soluble nonionic polyester.

13. The whitening and stain-removing laundry sheet according to claim 12, wherein a molecular weight of the hydrophobic modified acrylic polymer is 30,000-50,000 and a Brookfield viscosity of the hydrophobic modified acrylic polymer is 0-500 cPs.

14. The whitening and stain-removing laundry sheet according to claim 12, wherein a mass percentage of the hydrophobic modified acrylic polymer in the whitening and stain-removing laundry sheet is 1-3%, and a mass percentage of the water-soluble nonionic polyester in the whitening and stain-removing laundry sheet is 0.5-2%.

15. A method for preparing the whitening and stain-removing laundry sheet according to claim 1, comprising the following steps:
step 1: mixing water and the film-forming agent at 85-90° C. until uniform;
step 2: adding the chelating agent and then mixing until uniform;
step 3: adding the anionic surfactant, the nonionic surfactant and the anti-fouling agent, and then mixing until uniform;
step 4: adding the fluorescent whitening agent at 50-60° C. and then mixing until uniform;
step 5: adding the plant extract and mixing until uniform;
step 6: drying and shaping into a sheet to obtain a semi-finished laundry sheet; and
step 7: spraying the enzyme preparation onto the semi-finished laundry sheet to obtain the whitening and stain-removing laundry sheet.
